(19) United States
(12) Patent Application Publication
(10) Pub. No.: US 2012/0046372 A1
(43) Pub. Date: Feb. 23, 2012

(54) BLOWING AGENTS, FOAMABLE COMPOSITIONS AND FOAMS

(75) Inventors: Mary C. Bogdan, Buffalo, NY (US); Michael Ross, Cheektowaga, NY (US); David J. Williams, East Amherst, NY (US); Clifford P. Gittere, Amherst, NY (US)

(73) Assignee: HONEYWELL INTERNATIONAL INC., Morristown, NJ (US)

(21) Appl. No.: 13/210,188

(22) Filed: Aug. 15, 2011

Related U.S. Application Data
(60) Provisional application No. 61/374,978, filed on Aug. 18, 2010.

(51) Int. Cl. C08J 9/14

(52) U.S. Cl. 521/131

(57) ABSTRACT

A method of forming foam comprising: (a) providing at least a first relatively high pressure liquid comprising a first reactive component; (b) introducing into said relatively high pressure stream a liquid blowing agent composition comprising 1,3,3,3-tetrafluoropropene (HFO-1234ze) and/or HFCO-1233zd to produce a second stream at relatively high pressure and containing said blowing agent; and (c) mixing at least a portion of said third stream with a fourth stream containing a component reactive with said first component to produce a mixed reactive stream.

### CROSS-REFERENCES TO RELATED APPLICATIONS

This application claims priority benefit of U.S. Provisional Application No. 61/374,978, filed on Aug. 18, 2010, which is incorporated herein by reference.

### FIELD OF THE INVENTION

This invention relates to compositions, methods and systems having utility as blowing agents, foamable materials and foams, including compositions, systems and methods for forming polymeric foams.

### BACKGROUND OF THE INVENTION

Blowing agents are used extensively in the manufacturing of foam products. In certain typical arrangements, a blowing agent and a reactive base polymer or polymer precursor is provided under pressure, and then sprayed, extruded through a die, or expanded into a mold at a lower pressure.

Reactive chemical foam compositions, such as curable polyurethane foams, are presently well known and used in a number of different applications. The curable foam compositions typically comprise a two-part system, and in the case of polyurethane foams, one part of the composition includes an isocyanate component (the “A” side or part) and the other part includes a polyol component (the “B” side or part). It is frequently the case that chemical foaming agents, physical foaming agents, curing agents, catalysts or accelerators, as well as other modifying additives, may be incorporated in one or both of the component parts.

The mixing of the polyol and isocyanate components must occur at a proper flow ratio and mix under sufficient impingement mixing conditions for a final acceptable product to be obtained. In the past, particularly in the precise field of building thermally insulated containers for refrigeration units, shipping containers and the like, foam components were dispensed using static mixing equipment and then sprayed from a nozzle. It is sometimes desirable or advantageous to use more than one blowing agent to adjust the properties of the foam for a particular application.

In typical spray foam applications, each of the “A” and “B” side of the formulation are provided in separate drums or containers so that the reactive components can be kept separate until they are ready to be mixed in the spray equipment. For the purposes of convenience, safety and cost, it is common and desirable that each of these containers or drums maintains the contents under relatively low pressure. The contents of these drums are each then withdrawn from the container and pumped to a higher pressure adapted for the foaming reaction just prior to being mixed and sprayed from the nozzle or gun.

One constraint, however, resulting from the desire and the need to store and provide the reactive components at a relatively low pressure is that adjuvants, including particularly blowing agents, will not be provided as a component of either the “A” or “B” parts in such storage drums or containers unless such adjuvant is capable of remaining fully miscible and/or in solution at the relatively low pressure associated with the storage drum or container. Accordingly, it has heretofore been known to introduce relatively low boiling point blowing agents separately into the reactive component, either the “A” or “B” parts, at the intended location of use after the reactive component has been raised to the operating pressure of the gun or nozzle. However, because of the particular characteristics of such previously used blowing agents (such as HFC-134a), it has been necessary and common to include a separate mixing device, such as a static mixer, impingement mixture or the like, downstream of the injection point but upstream of the A/B part mixing device. Such a separate mixing device has been heretofore used in order to ensure that a relatively homogeneous mixture of the blowing agent and the reactive component(s) is present at the nozzle or tip of the spray device. According to prior practice, the failure to provide such a mixing device would frequently produce unacceptable foam as a result of the heterogeneous character of the material exiting the tip or nozzle of the spray device. The incorporation of such a mixer has therefore been considered necessary in order to ensure proper homogeneous integration of the separately added blowing agent with the combined polyol and/or isocyanate components. The need for such a further mixer is due to solubility/miscibility properties of the liquid blowing agents which have heretofore been added separately into the polyol and/or isocyanate streams. While such an arrangement has frequently been successful, it nevertheless has the disadvantage of increasing the cost and complexity of the system for forming and dispensing the foam. Furthermore, applicants have come to appreciate that the use of a liquid blowing agent having a high degree of solubility/miscibility in the pressurized polyol and/or isocyanate stream is highly advantageous, even in those circumstances in which it is desired to use a separate mixer.

Rigid polyurethane foams are preferably used for thermal insulation. For this application, they can be foamed into molded articles such as panels. It is also possible to fill hollow spaces of all types with a spray foam, in which case the foam, once formed, preferably also acts as a structural element and preferably has some load-bearing properties. It is furthermore possible to spray rigid polyurethane foams on tabular supports.

The quality and the properties of the rigid foam formed depend to a large extent on the structure and chemical composition of the blowing agent used. Because of certain suspected environmental problems, including the relatively high global warming potentials and/or ozone depletion potentials associated with the use of some of the compositions that have heretofore been used in blowing agent applications, it has become increasingly desirable to use fluids having low or even zero ozone depletion potential, such as hydrofluorocarbons (“HFCs”). Thus, the use of fluids that do not contain substantial amounts of ozone depleting chlorofluorocarbons (“CFCs”) or hydrochlorofluorocarbons (“HCFCs”) is desirable. Furthermore, some HFC fluids may have relatively high global warming potentials associated therewith, and it is desirable to use hydrofluorocarbon or other fluorinated fluids having as low global warming potentials as possible while maintaining the desired performance in use properties.

An acceptable replacement blowing agent should therefore posses a hard to achieve combination of properties. For example, such a blowing agent should meet environmental standards by having a low ozone depleting and global warming potential, and it preferably has low or no content of volatile organic compounds associated with the production of smog. It should also have low inhalation toxicity, and otherwise be relatively safe for use and exposure. Preferably the blowing agent is chemically stable and nonflammable.

The boiling point and vapor pressure of the blowing agent should be similar to the halogenated blowing agents in current use, so that current foam producing instruments may continue to be used without expensive refitting. For the same reason, the blowing agent's solubility in the polymer should also be at least as high as the solubility of blowing agents in current use. For applications involving polymeric foams as insulating material, the blowing agent should have low thermal conductivity, have a favorable closed cell size and shape, and have low permeability through the walls of the foamed closed cell polymer matrix. Blowing agents having a relatively high vapor pressure will also typically have a relatively high diffusion rate, which can present processing problems and effect properties such as permeability.

Applicants have also come to appreciate the substantial advantage that can be achieved for blowing agents, especially blowing agents for use in spray applied foams, which have solubility characteristics which provide certain important processing advantages and/or advantages in the characteristics of the foam produced, particularly when added to the reactive stream under high pressure and without the need for a mixing device at the point of or downstream of the injection point.

Applicants have thus come to appreciate a need for compositions, and particularly blowing agents, foamable compositions, foamed articles and methods and systems for forming foam, which provide beneficial properties and/or avoid one or more of the disadvantages noted above.

### BRIEF DESCRIPTION OF THE DRAWINGS

FIG. 1 is a schematic, process flow diagram showing one embodiment of the present invention.

FIGS. 2-9 are graphical representations of the example results.

### SUMMARY

One aspect of the present invention provides a method of forming foam comprising: (a) providing a first reactive, liquid phase fluid at a relatively high pressure, said fluid containing at least a first reactive component; (b) introducing into said first, relatively high pressure fluid a liquid blowing agent composition comprising 1,3,3,3-tetrafluoropropene (HFO-1234ze), 1-chloro,3,3,3-trifluoropropene (HFCO-1233zd) or combinations of these to produce a fluid containing said blowing agent; and (c) mixing at least a portion of said fluid containing said blowing agent with a fluid containing a component reactive with said first component to produce a mixed reactive fluid.

As used herein, the term “relatively high pressure” without more refers to a fluid or stream of fluid at a pressure above atmospheric pressure. As used herein, the terms “relatively high pressure” and “relatively low pressure” when used together with reference with respect to fluids and streams are used in a relative sense to designate the relative pressures of the two fluids and streams.

The term base polymer, as used herein, refers to any polymer or materials reactive to form a polymer having the appropriate physical properties conducive to the formation of cells containing the blowing agent during the spraying, extrusion or molding process used in the production of polymeric foam. The term polymer precursor refers to any material having the appropriate functional groups conducive to forming a polymer during the spraying, extrusion or molding process used in the production of polymeric foam

As the term is used herein, “liquid blowing agent” refers to the phase of the blowing agent under the conditions at which it is injected into the relatively high pressure stream containing the reactive component. It will be understood, however, that such “liquid blowing agent” will preferably change phase and become gaseous as it exits the nozzle or tip of the gun and is exposed to lower and/or ambient temperature and pressure conditions. Applicants have come to appreciate that in certain embodiments such a change at this location in the process of forming the foam can be highly advantageous from the perspective of forming foams which are frothy, that is, which do not run or weep when sprayed on vertical surfaces, which can be an important and valuable advantage in many applications.

### DESCRIPTION OF PREFERRED EMBODIMENTS

A preferred aspect of the present invention relates to methods of forming foam, preferably the forming of a foam by spraying, comprising: (a) providing a first fluid, preferably in a drum or container, at about a first pressure containing a first reactive component, preferably in the liquid phase; (b) raising the pressure of at least a portion of said first fluid, preferably in the form of a liquid stream withdrawn from said first drum or container, preferably by pumping, to produce a second, relatively high pressure stream containing the first reactive component; and (c) introducing into said second, relatively high pressure stream a liquid blowing agent composition comprising 1,3,3,3-tetrafluoropropene (HFO-1234ze), preferably trans-1,3,3,3-tetrafluoropropene (transHFO-1234ze), and/or 1-chloro,3,3,3-trifluoropropene (HFCO-1233zd), preferably trans-1-chloro,3,3,3-trifluoropropene (transHFCO-1233zd) to produce a third stream or fluid at relatively high pressure and containing said blowing agent; and (d) mixing at least a portion of said third stream fluid with a fourth stream fluid containing a component reactive with said first component to produce a mixed reactive stream or fluid. As mentioned above, applicants have found that the properties of the blowing agent according to the present invention are capable of producing unexpectedly superior results in terms of the ability of the blowing agent to form a highly homogeneous liquid composition comprising the first reactive component and the blowing agent. One advantage of applicants' development is the production of a foam having highly desirable properties, including thermal insulating performance, density characteristics, and froth quality, even without the need for a static or other type of mixer at the point of introducing the blowing agent or downstream thereof. According to certain preferred embodiments, the blowing agent of the present invention is introduced into the relatively high pressure reactive stream by simple injection of the liquid blowing agent into a conduit containing the reactive stream.

Although it is contemplated that the blowing agent composition of the present invention may be introduced, and preferably as a third stream addition, to either of the high pressure streams, it is preferred in certain embodiments that the blowing agent composition is introduced, preferably by injection and without an associated additional mixer, to the polyol component or part B, of a spray foam polyurethane system. Furthermore, it is contemplated that the amount of the blowing agent of the present invention may be added in a wide range of concentrations relative to the weight of the high-pressure polyol stream. However, in certain preferred embodiments, the blowing agent of the present invention is present in an amount of from about 1% by weight to about 30% by weight based upon the total weight of the polyol component (including any other blowing agent or other adjuvants included with the polyol in the relatively low pressure drum), with an amount of from about 1 to about 15 weight percent being more preferred in certain embodiments. In certain highly preferred embodiments, the blowing agent of the present invention is present in an amount of from about 1% by weight to about 5% by weight based upon the total weight of the polyol component, once again including any other co-blowing agent or adjuvants contained therein.

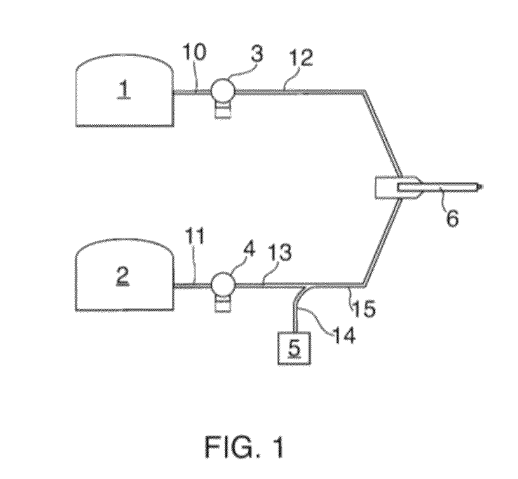

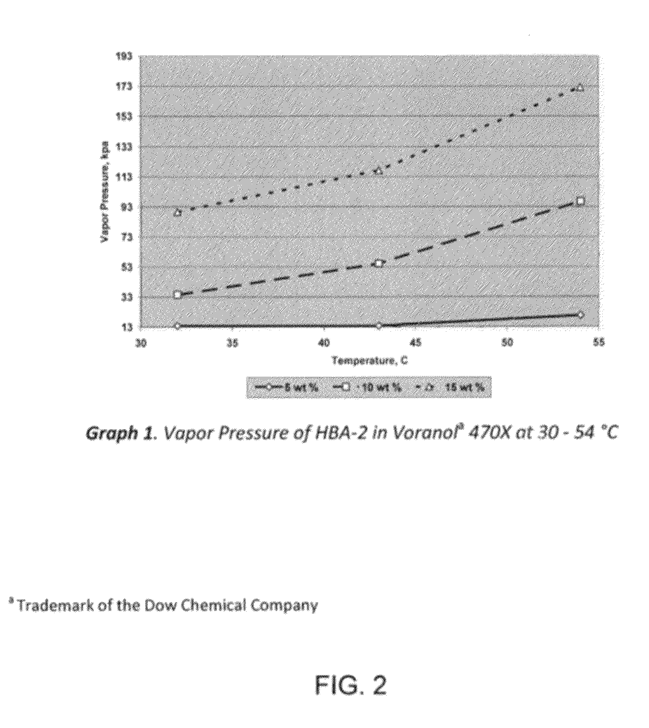

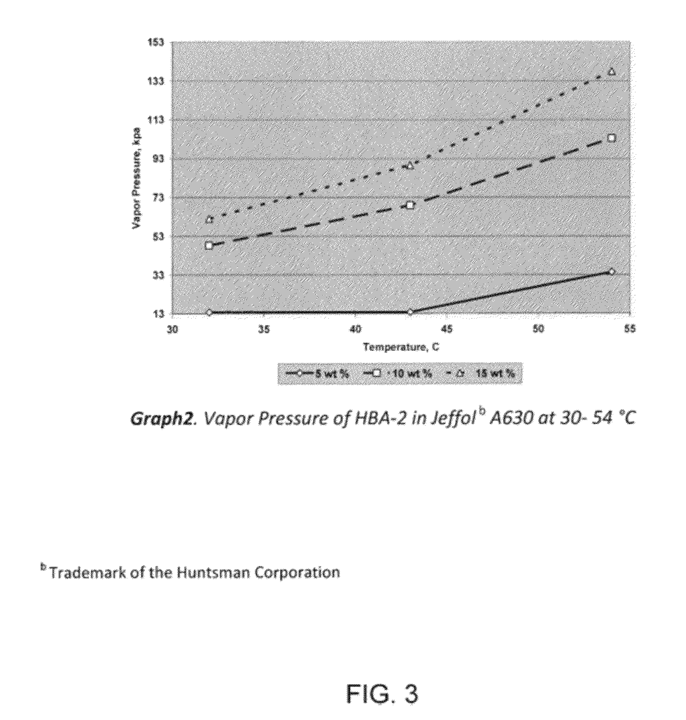

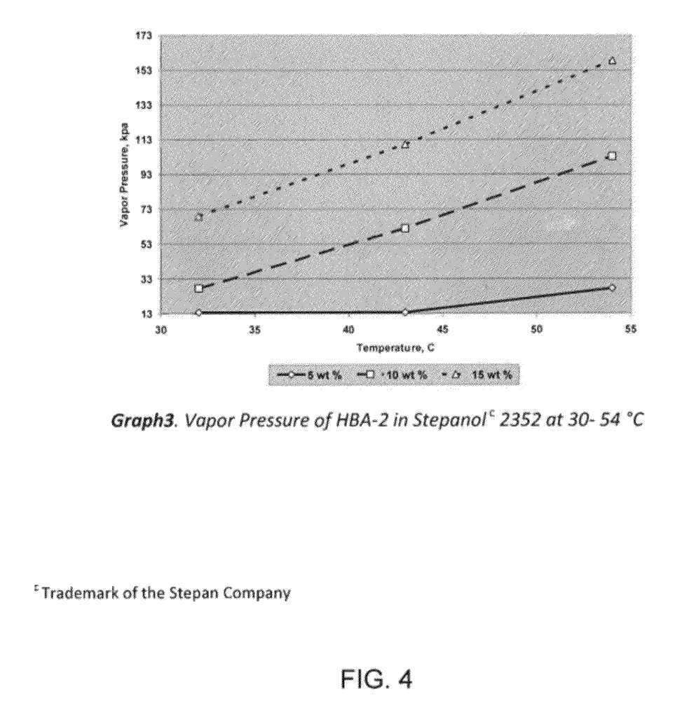

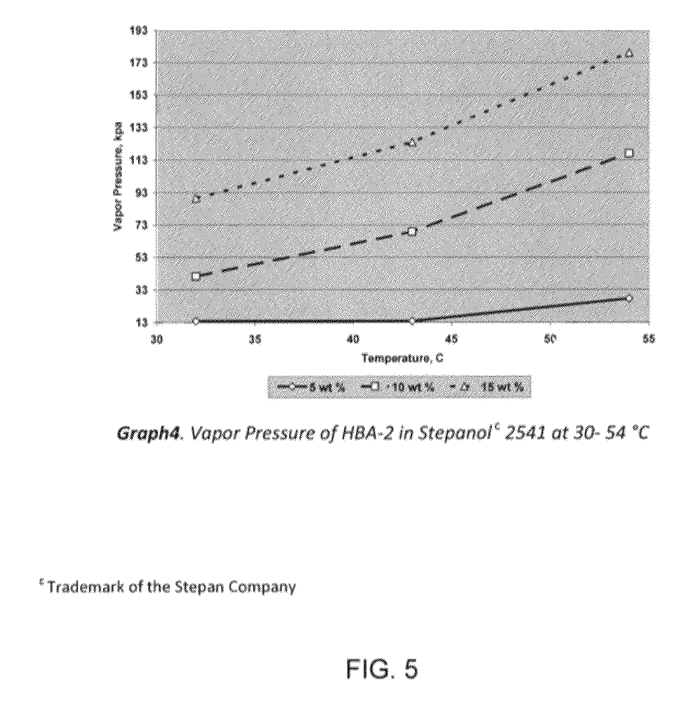

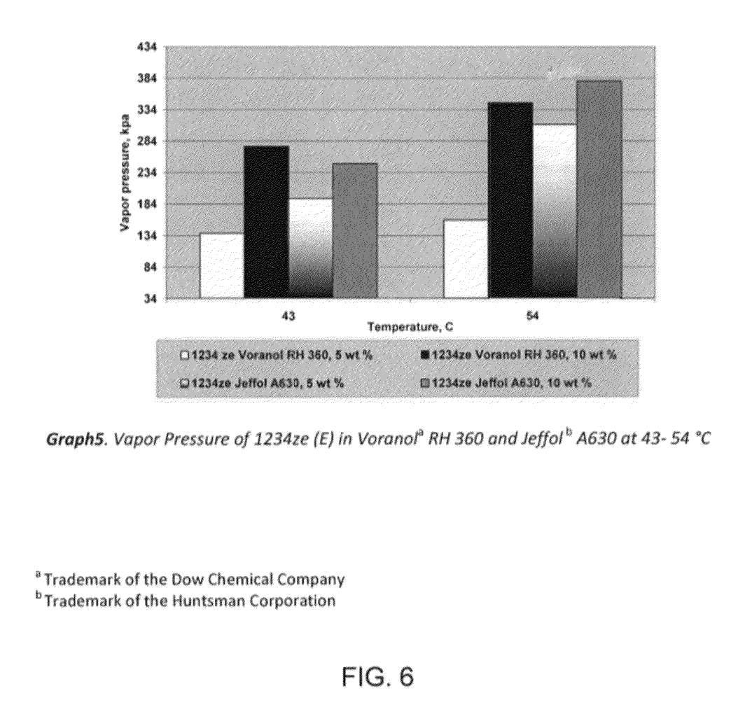

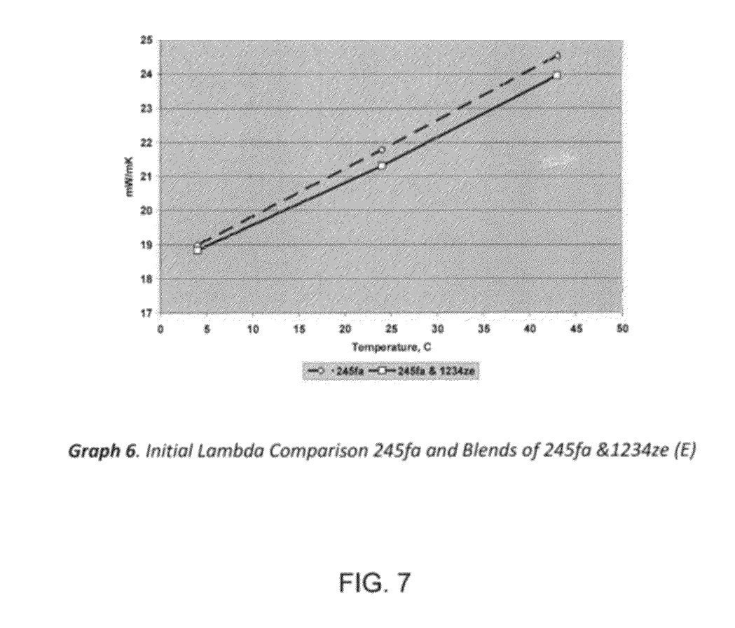

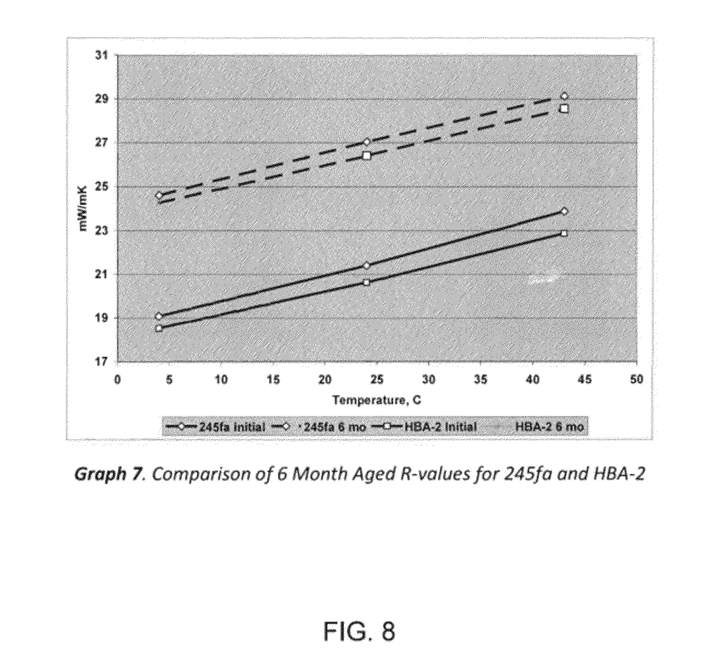

For purposes of illustration, but not necessarily by way of limitation, FIG. 1 illustrates schematically one embodiment according to the method, equipment and system aspects of the present invention. According to this embodiment, a first relatively low pressure container or drum 1 and a second relatively low pressure container or drum 2 is provided. According to certain preferred embodiments, each of these drums is readily transportable such that it can be moved to the site or location at which the foaming operation is to take place. Each of these drums contains a separate reactive component necessary for forming foam and which will be brought into spraying apparatus 6, which may be a spray gun or the like. In preferred embodiments, the spray gun 6 incorporates a mixing device (not shown), such as a static mixer, a high-pressure mixer or an impingement mixer. In a typical polyurethane foaming system, for example, drum 1 contains the isocyanate component or part A (which includes adjuvants typically used in this part) and drum 2 contains the polyol component or part B (which includes adjuvants typically used in this part). Each of these drums is preferably maintained at a relatively low pressure for the purposes of cost, convenience and safety. Lines 10 and 11 are attached respectively to drums 1 and 2 for withdrawing the contents thereof and introducing these streams into pumps 3 and 4 respectively. The output streams 12 and 13 from these pumps are a higher pressure than respective streams 10 and 11, with the pressure being selected as appropriate for use in connection with the particular foam material and equipment being used. According to preferred embodiments, the blowing agent of the present invention is introduced into line 13 from a pressurized tank 5 or from a pump (not shown) which brings the blowing agent composition to the appropriate pressure for injection into line 13. The combined stream contained in line 15 is then introduced, together with the stream in line 12 into the spray gun 6, where it is mixed and the mixed content are then ejected from the nozzle or tip thereof to form the foam or froth according to the present invention. Although it is not believed to be preferred at the present time, applicants contemplate that, in certain embodiments, it may be possible or desirable to introduce the blowing agent composition of the present invention into line 12 and/or directly into spray gun 6.

Furthermore, applicants have found that the advantageous properties and features in accordance with the present invention are exhibited for blowing agent of the present invention which comprise additional or auxiliary co-blowing agents. For example, the blowing agent of the present invention in certain embodiments comprises, in addition to HFO-1234ze and/or HFCO-1233zd, one or more other liquid co-blowing agents, including water and/or HFC and/or HFO and/or HFCO blowing agent such as: 1,1,1,3,3-pentafluoropropane (HFC-245fa); 1,1,1,3,3-pentafluorobutane (HFC-365mfc); 1-fluoro-1,1 dichloroethane (HCFC-141b); cis-1,1,1,4,4,4-hexafluoro-2-butene; and combinations of any two or more of these.

Although it is contemplated that the amount of HFO-1234ze and/or HFCO-1233zd and each of the co-blowing agents in accordance with the present invention can vary widely, in certain preferred embodiments the ratio by weight of HFO-1234ze and/or HFCO-1233zd to the total other liquid co-blowing agent is from about 1:0.01 to about 1:0.6, with a weight ratio about 1:0.03 to about 1:0.5 being preferred in certain embodiments. Although it is contemplated that the above-noted ratios will apply to all liquid co-blowing agents, is highly preferred that the ratio of from about 1:0.01 to about 1:0.6, and even more preferably from about 1:0.03 to about 1:0.5, applies to each of the following co-blowing agents: 1,1,1,3,3-pentafluoropropane (HFC-245fa); 1,1,1,3,3-pentafluorobutane (HFC-365mfc); 1-fluoro-1,1 dichloroethane (HCFC-141b); cis-1,1,1,4,4,4-hexafluoro-2-butene; and combinations of any two or more of these.

Applicants have found that the blowing agent compositions of the present invention have substantial advantage by virtue of being able to satisfy many or all of the aforementioned desirable properties for blowing agents while at the same time providing excellent solubility, and in certain circumstances unexpectedly improved solubility, in one or more of the reactive component which are used to form the polymeric material which comprises the walls and structure of the foam. In fact, the solubility of the present blowing agents is so unexpectedly superior in the reactive polyol component of many polyurethane formulations that it permits the use of spray application apparatus which does not need to contain, and preferably in certain circumstances does not contain, a static mixer or mixing device at the point of injection of the blowing agent or downstream thereof. As those skilled in the art will understand, many if not all currently used spray guns and associated equipment for the spraying of foam include an in-line mixing device (such as a static mixer) to ensure proper and thorough mixing of the reactive components of the foamable composition, together with any adjuvants contained in the respective storage drums or containers for such reactive components. Because of the high level of solubility of the present blowing agents in many reactive components, but particularly in the polyol component used in polyurethane based foamable compositions, foams with exceptional and highly desirable properties can be achieved either with or without the use of an additional static mixer in the foam dispensing apparatus. Those skilled in the art will appreciate the advantages that can be achieved as a result of the flexibility of a process which permits the introduction of a liquid blowing agent, either as the sole blowing agent or as an auxiliary blowing agent, downstream of the point at which the other reactive materials, such as the polyol and isocyanate components, had been already been mixed. Such an arrangement, for example, has the advantage of providing the ability to advantageously introduce the blowing agent of the present invention at high pressure and in liquid form into the foaming apparatus, preferably the spray foaming apparatus, without the need for a mixing device at that point of introducing the liquid blowing agent, or at a point downstream thereof and upstream of the mixing device used for mixing the reactive components.

The HFO-1234ze used in accordance with the present invention may be provided as cis-HFO-1234ze or as trans-HFO-1234z4 alone. Alternatively, the HFO-1234ze is a mixture of cis- and trans-HFO-1234ze, which may be provided in any ratio within the scope of the present invention. The use of trans-HFO-1234ze is preferred in certain embodiments.

The HFCO-1233zd used in accordance with the present invention may be provided as cis-HFCO-1233zd or as trans-HFO-1233zd alone. Alternatively, the HFCO-1233zd is a mixture of cis- and trans-HFCO-1233ad, which may be provided in any ratio within the scope of the present invention. The use of trans-HFC-1233zd is preferred in certain embodiments.

In view of the teachings contained herein, it is expected that those skilled in the art will be able to determine the relative amounts of HFO-1234ze and/or HFCO-1233zd and co-blowing agent (such as 1,1,1,3,3-pentafluoropropane (HFC-245fa); 1,1,1,3,3-pentafluorobutane (HFC-365mfc); 1-fluoro-1,1 dichloroethane (HCFC-141b); cis-1,1,1,4,4,4-hexafluoro-2-butene; and combinations of any two or more of these) to be used to provide an effective amount to achieve one or more of the foregoing advantages discussed herein. In one embodiment, the blowing agent composition of the present invention comprises from about 99 to about 50 weight % of HFO-1234ze and/or HFCO-1233zd and from about 50 to about 1 weight % of liquid co-blowing agent, including preferably a co-blowing agent selected from the group consisting 1,1,1,3,3-pentafluoropropane (HFC-245fa); 1,1,1,3,3-pentafluorobutane (HFC-365mfc); 1-fluoro-1,1 dichloroethane (HCFC-141b); cis-1,1,1,4,4,4-hexafluoro-2-butene; and combinations of any two or more of these. In a further embodiment, the blend includes approximately 90 to about 99 weight % HFO-1234ze and/or HFCO-1233zd and approximately 1 to about 10 weight % of a liquid co-blowing agent, including one or more of the aforementioned co-blowing agents. In an even further embodiment, the blend includes approximately 90 to about 95 weight % HFO-1234ze and/or HFCO-1233zd and approximately 5 to about 10 weight % of a liquid co-blowing agent, including one or more of the aforementioned co-blowing agents.

The blowing agent compositions of the instant invention may also include one or more adjuvants or additional components, depending upon the intended use. While not limited thereto, adjuvants may include the following: co-blowing agents, co-solvents, surfactants, polymer modifiers, colorants, dyes, solubility enhancers, rheology modifiers, plasticizing agents, flame retardants, flammability suppressants, antibacterial agents, viscosity reduction modifiers, fillers, vapour pressure modifiers, nucleating agents, catalysts, polyols, isocyanates, stabilizers, and any combination of two or more of these.

In certain embodiments, particularly in the context of foaming composition, the adjuvant is at least a co-blowing agent, which may be one or more fluoroalkenes, fluoroalkanes, hydrofluoroolefins, hydrofluorocarbons, hydrochlorofluorocarbons, esters, ethers, alcohols, or hydrocarbons.

Although in preferred embodiments the present invention is directed to thermosetting foams, it will be appreciated that the foamable composition of the present invention may be used in connection with either thermosetting or thermoplastic foams. In connection with thermosetting foam embodiments, it is preferred that the thermoset foam component is selected from components capable of forming polyurethane foam, polyisocyanurate foam, phenolic foam, and two or more of these.

The present blowing agent is adaptable for use to form a wide variety of foamable compositions and/or thermoset or thermoplastic foams. The foam preferably includes a plurality of polymeric cells, as is generally understood in the art. Although in certain preferred embodiments of the present invention is directed to spray applied foams, it is contemplated that the blowing agents of the present invention may be used to advantage in connection with foams of other types. Furthermore, foams may be in the form of a block, a slab, a laminate, a rigid foam, a closed cell foam, a flexible foam, and the like. In preferred embodiments, however, the foam is a spray applied foam, appliance foam (e.g. refrigerator foam, freezer foam, water heater foam, etc.), or the like. In further embodiments, the foam may be a pour foam, for example a discontinuous or continuous panel foam or an insulated transportation container foam.

### EXAMPLES

### Example 1

### Blowing Agent Properties

It is generally desirable for blowing agents to have certain basic environmental and toxicological properties. A summary of information regarding certain physical properties of certain blowing agents is provided in Table 1 below. As used herein, the term HBA-2 is designates and means transHCFO-1233zd.

TABLE 1
Comparative Blowing Agent Properties

| | COMPOUND | | | | |
|---|---|---|---|---|---|
| Property | 1234ze(E) | 134a | HBA-2 | cyclo-pentane | 245fa |
| Molecular Weight | 114 | 102 | <134 | 72 | 134 |
| Boiling Point (° C.) | −19 | −26 | 245fa < T_{BP} < 141b | 49.3 | 15.3 |
| Flashpoint (° C.) | None | None | None | −7/19.4 | None |
| | (at ~23° C.) | | | | |
| LFL/UFL (Vol %-air) | None | None | None | 1.5-8.7 | None |
| | (at ~23° C.) | | | | |
| GWP (100 yr) | 6 | 1430* | <15 | <15 | 1030* |

*2007 Technical Summary. Climate Change 2007: The Physical Science Basis. Contribution of Working Group 1 to the Fourth Assessment Report of the Intergovernmental Panel on Climate Change.

Initial stages of testing of trans HFO-1234ze and HFCO-1233zd have indicated that toxicological properties are acceptable, and the data suggests that toxicity will not be a problem for commercial use as blowing agents of either 1234ze(E) or HBA-2.

The vapor pressure of a spray foam polyol blend is influenced by many factors such as the polyol type or types, surfactants and the blowing agent used as well as the concentrations of each. Since the polyol is in many situations the major component of the spray foam polyol blend, the impact of blowing agent concentration and temperature on the vapor pressure of polyol solutions is an important step in assessing the viability of a composition's usefulness as a new blowing agent. Applicants have conducted testing to determine the vapor pressure of transHFO-1234ze and transHFCO-1233zd in a variety of commercially available polyol formulations. Applicants have determined that at a concentration of about 10 wt % HBA-2 in a variety of commercially available polyols exhibits a vapor pressure at 43 C that is below the pressure level that is required to distend a traditional drum (69 kpa). This will potentially allow for the reduction in SPF system vapor pressure to below the levels currently exhibited by 245fa.

The following graphs provide the results of this testing.

### Comparative Example 1A

Each of HCFC-12, HCFC-22, HFC-245fa and HFC-134a are utilized as liquefied blowing agents in a third stream addition system of the type illustrated generally in FIG. 1, except that a mixing device is included at or about the location that each of the blowing agents is injected into the pressurized polyol stream. Approximately 6% by weight of HFC-245fa blowing agent is included in the low pressure polyol container. The processing conditions used are the same as those reported in Table 2 below. A substantially homogeneous mixture enters the spraying apparatus and produces an acceptable foam.

### Comparative Example 1B

Each of HFC-12, HFC-22 and HFC-134a are utilized as liquefied blowing agents in a third stream addition system of the type illustrated generally in FIG. 1. No mixing device is included at or about the location that each of the blowing agents is injected into the pressurized polyol stream. Approximately 6% by weight of HFC-245fa blowing agent is included in the low pressure polyol container. The processing conditions used are the same as those reported in Table 2 below. A substantially non-homogeneous mixture enters the spraying apparatus, with alternating slugs of polyol and blowing agent and during a gun and producing an unacceptable foam.

### Comparative Example 1C

A first set of data is generated using a traditional spray foam apparatus in which approximately 6% by weight of HFC-245fa blowing agent is included in the low pressure polyol container according to the general schematic arrangement shown in FIG. 1, except that no auxiliary blowing agent was added to the system. The processing conditions used for the test are summarized in Table 2 under the heading “245fa.”

### Example 2

A second set of data is generated using the same traditional spray foam apparatus described in connection with Comparative Example 2A and using the same 6% by weight of HFC-245fa blowing agent in the low pressure polyol container. In addition, however, approximately about 10% by weight of blowing agent comprising transHFO-1234zeis (based on the weight of the high pressure polyol component stream) is added to the high pressure polyol stream by way of an injection pump, and the combined stream is then introduced into the spraying apparatus without an intermediate mixing device. A substantially homogeneous mixture enters the spraying apparatus and produces an acceptable foam. The processing conditions used for the test are summarized in Table 2 under the heading “1234ze/245fa.”

TABLE 2
Spray Foam Equipment And Processing Parameters Used.

| | Settings | |
|---|---|---|
| | 245fa | 1234ze/245fa |
| Equipment | | |
| Proportioning unit | Gusmer H2000 | Gusmer H2000 |
| Hose length, m (ft) | 9.1 | 9.1 |
| Processing temperatures, ° C. (° F.) | | |
| Hose | 38-43 | 38-43 |
| Isocyanate | 38-43 | 38-43 |
| Polyol | 24-38 | 24-38 |
| Pressure, Bar (psi) | | |
| Static/Dynamic | | |
| Isocyanate | 10.5/10.5 | 10.5/10.5 |
| Polyol | 10.5/10.5 | 10.5/10.5 |
| Auxiliary pump | — | 85% |

| | |
|---|---|
| GUN | GX7 |
| | Module #1 PCD 70 |

The results of this test indicate that the 1234ze (E) was readily solubilized in the high pressure polyol stream and processed well through the gun without the use of an intermediate mixing device. The foam surface was smooth. Since 245fa systems have immediate cream times, the reactivity was similar with the 245fa and the 245fa/1234ze (E) systems. The presence of both blowing agents was confirmed by GCMS. The total blowing agent concentration was approximately equivalent in both foams. Table 3 below summarizes the foam densities produced. The initial lambdas are displayed in Graph 5. Initial lambda values indicate that the 245fa/1234ze (E) foams had equivalent or slightly better lambdas than that of the 245fa foam. The formulation catalysis used in the 245fa system is designed for a liquid blowing agent. When this system is used with the 245fa/1234ze blend, the result is a greater loss of blowing agent than typically seen during spraying of the foam. Therefore, the foam density did not significantly decrease. With modification of the formulation it is possible that the fugitive emission losses during the foaming reaction can be reduced.

TABLE 3
Analysis of 245fa vs 1234ze (E) & 245fa foams.

Data

| Test | 245fa | 12434ze/245fa |
|---|---|---|
| Density, kg/m3 | 34 | 35.2 |

### Example 3

HFCO-1233zd is evaluated for long term aging of the commercially processed spray foam samples, for solubility in the foam matrix, and for use as a blend with 245fa. In the spray foam industry, a 6 month aged lambda is typically considered. Table 4 below contains a summary of the formulations used in this long term aging study. The foam prepared for this study was sprayed under the processing conditions stated in Table 5. The data in Graph 7 illustrates that the HBA-2 and 245fa foams aged at an equivalent rate and the HBA-2 foams sprayed through commercial equipment still exhibit better aged lambdas that the 245fa foams tested.

TABLE 4
Generic Spray Foam Polyol Premixes For Evaluation of HBA-2

High Water

| Blowing Agent | HFC-245fa | HBA-2 |
|---|---|---|
| Components/ | Concentration, phpp | |
| Polyether polyol blend | 50 | 50 |
| Polyester polyol | 43.8 | 43.8 |
| Other polyol | 6.2 | 6.2 |
| Silicone surfactant | 1.25 | 1.25 |
| Amine Catalyst | 2 | 2 |
| Metal Catalyst | 0.02 | 0.02 |
| Flame Retardant | 12.5 | 12.5 |
| Water | 1.5 | 1.5 |
| Blowing Agent | 16.3 | equi-molar |
| Isocyanate | | |
| Index-110 | 141.8 | 141.8 |

TABLE 5
Spray Foam Equipment And Processing Parameters Used.

| | Settings | |
|---|---|---|
| Equipment | HFC-245fa | HBA-2 |
| Proportioning unit | Gusmer H2000 | Gusmer H2000 |
| Hose length, m (ft) | 9.1 | 9.1 |
| Processing temperatures, ° C. (° F.) | | |
| Hose | 38-43 | 54 |
| Isocyanate | 38-43 | 54 |
| Polyol | 24-38 | 54 |
| Pressure, Bar (psi) | | |
| Static/Dynamic | | |
| Isocyanate | 13.8/13.8 | 14.5/13.8 |
| Polyol | 13.8/13.8 | 13.8/13.8 |

| | |
|---|---|
| GUN | GX7 |
| | Module #1 PCD 70 |

An analytical procedure is utilized which allows the estimation of total blowing agent in foam, and the distribution of the blowing agent through the foam. This includes an estimation of the blowing agent content in the foam cells and from the total and cell gas numbers a calculation of the theoretical level of the blowing agent in the foam matrix. Table 6 summarizes the formulation used and processing conditions to make the foams for the analysis. The foams were prepared via hand mix. The data in Table 7 indicates that HBA-2 exhibits similar blowing agent distribution through the foam to that seen with 245fa.

TABLE 6
Generic Spray Foam Polyol Premixes For Evaluation of HBA-2

| | | |
|---|---|---|
| Blowing Agent | 245fa | HBA-2 |

| | |
|---|---|
| Components/ | Concentration, phpp |

| | | |
|---|---|---|
| Polyether polyol blend | 50 | 50 |
| Polyester polyol | 43.8 | 43.8 |
| Other polyol | 6.2 | 6.2 |
| Silicone surfactant | 1.25 | 1.25 |
| Amine Catalyst | 2 | 2 |
| Flame Retardant | 12.5 | 12.5 |
| Water | 1.5 | 1.5 |
| Blowing Agent | 16.3 | equi-molar |
| Isocyanate | | |
| Index-110 | 141.8 | 141.8 |
| Processing temperature | Polyol 10 C/Iso 24 C | |

TABLE 7
Blowing Agent Distribution on Foam

| | |
|---|---|
| 245fa | HBA-2 |

| | |
|---|---|
| | Relative ratio of blowing |
| Disatribution | agent throughout the foam |

| | | |
|---|---|---|
| Total Blowing Agent | 1 | 1 |
| Cells Gas | 0.3 | 0.3 |
| Balance | 0.7 | 0.7 |

Blends of blowing agents are often used in transition periods. This allows for the benefits of the new material without the cost and formulation optimization impacts often associated with a complete transition. In the case of 245fa, the lower boiling point has sometimes proven a challenge for shipping systems in hot climates. In this paper a blend of 245fa is compared to a 50/50 mole % blend of 245fa and HBA-2. The advantage would be reduction in vapor pressure and GWP of the blowing agents being used. The formulation used for the comparison is contained in Table 8. Handmix foams were prepared.

The vapor pressure for these premixes is presented in Graph 8. The 50% reduction in 245fa does provide an 8% reduction in vapor pressure at 54 C while providing a 50% reduction in GWP of the foam formulation. The reduction in vapor pressure was not detectable at 43 C due to the limitations of the test procedure.

TABLE 8
Generic Spray Foam Polyol Premixes For Evaluation of
245fa/HBA-2Blend

| | | |
|---|---|---|
| Blowing Agent | 245fa | 245/HBA-2 |

| | |
|---|---|
| Components/ | Concentration, phpp |

| | | |
|---|---|---|
| Polyether polyol blend | 50 | 50 |
| Polyester polyol | 43.8 | 43.8 |
| Other polyol | 6.2 | 6.2 |
| Silicone surfactant | 1.25 | 1.25 |
| Amine Catalyst | 2 | 2 |
| Flame Retardant | 12.5 | 12.5 |
| Water | 1.5 | 1.5 |
| Blowing Agent | 16.3 | equi-molar |
| Isocyanate | | |
| Index-110 | 141.8 | 141.8 |
| Processing temperature | Polyol 10 C/Iso 24 C | |

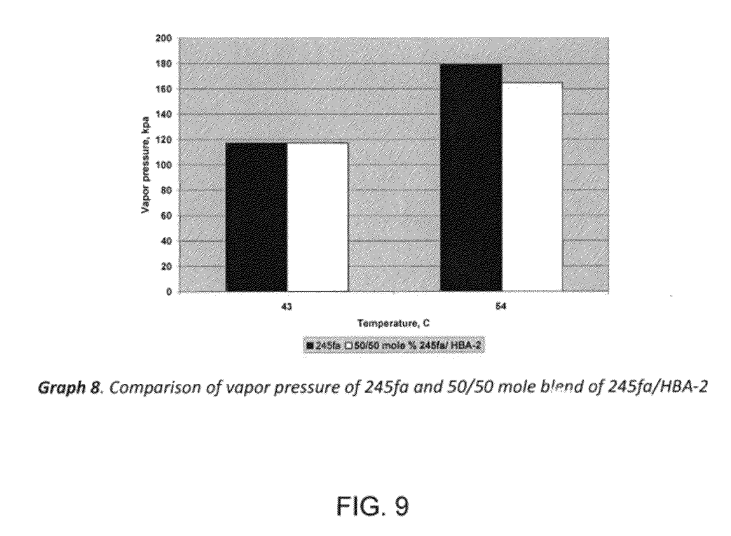

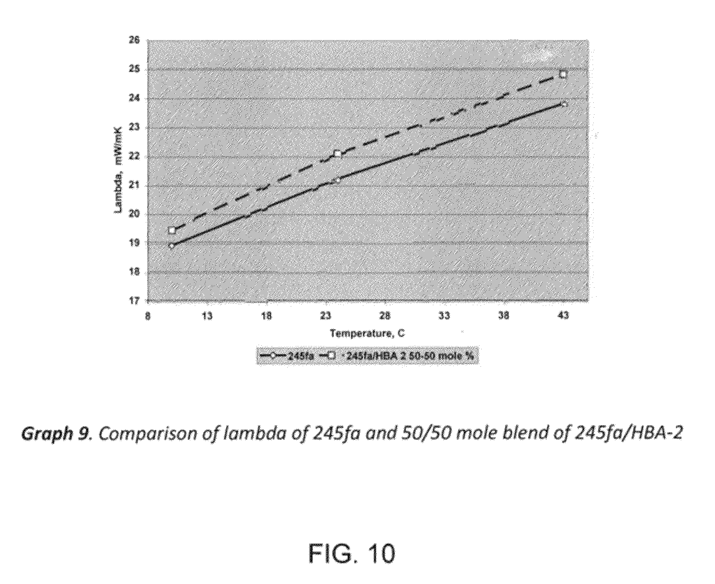

Foam quality results from the above-noted tests are presented in Table 9 and FIG. 9.

TABLE 9
Comparison of foam properties 245fa vs 50/50 blend 245fa HBA-2

| Foam reactivity | 245fa | 245fa/HBA-2 |
|---|---|---|
| Cream time, sec | 13 | 15 |
| Gel Time, sec | 26 | 28 |
| Tack Free Time, sec | 34 | 38 |
| Density, kg/m3 | 35.7 | 36.3 |

This testing reveals that the blowing agent blend of 245fa/HBA-2 provides similar properties to 245fa foams tested. The lambda is slightly higher as is the density. It is important to note that this data represents substitution of HBA-2 in a formulation intended for 245fa.

We claim:

1. A method of forming foam comprising: (a) providing at least a first relatively high pressure liquid comprising a first reactive component; (b) introducing into said relatively high pressure stream a liquid blowing agent composition comprising 1,3,3,3-tetrafluoropropene (HFO-1234ze) and/or HFCO-1233zd to produce a second stream at relatively high pressure and containing said blowing agent; and (c) mixing at least a portion of said third stream with a fourth stream containing a component reactive with said first component to produce a mixed reactive stream.

2. The method of claim 1 wherein said blowing agent further comprises a liquid co-blowing agent.

3. The method of claim 1 wherein said blowing agent further comprises a liquid co-blowing agent selected from the group consisting of water; 1,1,1,3,3-pentafluoropropane (HFC-245fa); 1,1,1,3,3-pentafluorobutane (HFC-365mfc); 1-fluoro-1,1 dichloroethane (HCFC-141b); cis-1,1,1,4,4,4-hexafluoro-2-butene; and combinations of any two or more of these.

4. The method of claim 1 wherein the HFO-1234ze is trans-HCFO-1234zd.

5. The method of claim 4 wherein said blowing agent further comprises a liquid co-blowing agent selected from the group consisting of 1,1,1,3,3-pentafluoropropane (HFC-245fa); 1,1,1,3,3-pentafluorobutane (HFC-365mfc); 1-fluoro-1,1 dichloroethane (HCFC-141b); cis-1,1,1,4,4,4-hexafluoro-2-butene; and combinations of any two or more of these.

6. The method of claim 1 wherein said blowing agent further comprises 1,1,1,3,3-pentafluoropropane (HFC-245fa).

7. The method of claim 1 wherein said blowing agent further comprises 1,1,1,4,4,4-hexafluoro-2-butene.

8. The method of claim 1 wherein said first liquid comprises at least one adjuvant selected from co-blowing agents, co-solvent, surfactants, polymer modifiers, colorants, dyes, solubility enhancers, rheology modifiers, plasticizing agents, flame retardants, flammability suppressants, antibacterial agents, viscosity reduction modifiers, fillers, vapour pressure modifiers, nucleating agents, catalysts, polyols, isocyanates, stabilizers, and any combination of two or more of these.

9. The method of claim 1 wherein the HFO-1233zd is trans-HCFO-1233zd.

10. The method of claim 1 wherein the blowing agent comprises a combination of HFO-1234ze and trans-HCFO-1233zd.
